(19) United States
(12) Patent Application Publication
(10) Pub. No.: US 2006/0143411 A1
(43) Pub. Date: Jun. 29, 2006

(54) Techniques to manage partition physical memory

(76) Inventor: Dennis M. O'Connor, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/021,323

(22) Filed: Dec. 23, 2004

(51) Int. Cl. G06F 12/00

(52) U.S. Cl. 711/153

(57) ABSTRACT

System, method and apparatus to partition physical memory for a device are described.

### BACKGROUND

A communication system may comprise multiple nodes, with each node having a processing system. The processing system may include, for example, a processor and a memory subsystem. The processing system may assist in communications between the various nodes. In addition, the processing system may be used to execute various application programs, sometimes concurrently. Consequently, the processing system may need to support multiple execution contexts in which multiple sets of independent services and applications are executed.

The processing system may divide the physical address space of a processor into partitions using a partition table and may restrict the processing system's access to memory and memory-mapped resources using these partitions. Some processing systems in a non-secure, non-kernel operating mode may be permitted to access only resources in the “active partition” it is operating in. This makes sharing libraries difficult and makes inter-processing system communication awkward and inefficient. Accordingly, there may be a need to permit the processing system to access a plurality of partitions, besides the active one, with restrictions on the type of access permitted and to permit this access without any changes to the processing system pipeline, no additional bits in the processing system's translation lookaside buffer (TLB), and no performance impact compared to the previous embodiments of the processing system. There may be a need for a mechanism by which a processing system may allow non-kernel, non-secure tasks to share partitions or parts of partitions.

### BRIEF DESCRIPTION OF THE DRAWINGS

FIG. 1 illustrates a block diagram of a system 100.

FIG. 2 illustrates a partial block diagram of a processing system 200.

FIG. 3 illustrates a memory structure 300.

FIG. 4 illustrates a partition table structure 400.

FIG. 5 illustrates a partition access register 500.

FIG. 6 illustrates a programming logic 600.

### DETAILED DESCRIPTION

Some embodiments may be arranged to create and manage multiple physical domains for a processing system. For example, the processing system may create multiple physical domains in a memory subsystem, with the domains isolated from each other. The multiple physical domains may be used for any number of operations, such as isolating different execution threads or processes from each other. The multiple physical domains may be managed so that a process running in one physical domain is unable to access the physical memory for a separate physical domain. The embodiments are not limited in this context.

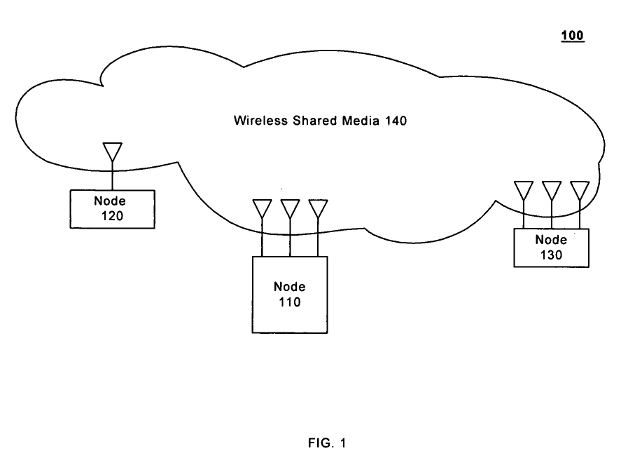

FIG. 1 illustrates a block diagram of a system 100. System 100 may comprise, for example, a communication system having multiple nodes. A node may comprise any physical or logical entity having a unique address in system 100. Examples of a node may include, but are not necessarily limited to, a computer, server, workstation, laptop, ultra-laptop, handheld computer, telephone, cellular telephone, personal digital assistant (PDA), router, switch, bridge, hub, gateway, wireless access point, and so forth. The unique address may comprise, for example, a network address such as an Internet Protocol (IP) address, a device address such as a Media Access Control (MAC) address, and so forth. The embodiments are not limited in this context.

The nodes of system 100 may be arranged to communicate different types of information, such as media information and control information. Media information may refer to any data representing content meant for a user, such as voice information, video information, audio information, text information, alphanumeric symbols, graphics, images, and so forth. Control information may refer to any data representing commands, instructions or control words meant for an automated system. For example, control information may be used to route media information through a system, or instruct a node to process the media information in a predetermined manner.

The nodes of system 100 may communicate media and control information in accordance with one or more protocols. A protocol may comprise a set of predefined rules or instructions to control how the nodes communicate information between each other. The protocol may be defined by one or more protocol standards as promulgated by a standards organization, such as the Internet Engineering Task Force (IETF), International Telecommunications Union (ITU), the Institute of Electrical and Electronics Engineers (IEEE), and so forth.

System 100 may be implemented as a wired communication system, a wireless communication system, or a combination of both. Although system 100 may be illustrated using a particular communications media by way of example, it may be appreciated that the principles and techniques discussed herein may be implemented using any type of communication media and accompanying technology. The embodiments are not limited in this context.

When implemented as a wired system, for example, system 100 may include one or more nodes arranged to communicate information over one or more wired communications media. Examples of wired communications media may include a wire, cable, printed circuit board (PCB), backplane, switch fabric, semiconductor material, twisted-pair wire, co-axial cable, fiber optics, and so forth. The communications media may be connected to a node using an input/output (I/O) adapter. The I/O adapter may be arranged to operate with any suitable technique for controlling information signals between nodes using a desired set of communications protocols, services or operating procedures. The I/O adapter may also include the appropriate physical connectors to connect the I/O adapter with a corresponding communications medium. Examples of an I/O adapter may include a network interface, a network interface card (NIC), disk controller, video controller, audio controller, and so forth. The embodiments are not limited in this context.

When implemented as a wireless system, for example, system 100 may include one or more wireless nodes arranged to communicate information over one or more types of wireless communication media. An example of a wireless communication media may include portions of a wireless spectrum, such as the radio-frequency (RF) spectrum. The wireless nodes may include components and interfaces suitable for communicating information signals over the designated wireless spectrum, such as one or more antennas, wireless transmitters/receivers (“transceivers”), amplifiers, filters, control logic, and so forth. Examples for the antenna may include an internal antenna, an omni-directional antenna, a monopole antenna, a dipole antenna, an end fed antenna, a circularly polarized antenna, a micro-strip antenna, a diversity antenna, a dual antenna, an antenna array, a helical antenna, and so forth. The embodiments are not limited in this context.

Referring again to FIG. 1, system 100 may comprise a wireless communication system, having representative nodes 110, 120 and 130. Although FIG. 1 is shown with a limited number of nodes in a certain topology, it may be appreciated that system 100 may include more or less nodes in any type of topology as desired for a given implementation. The embodiments are not limited in this context.

As shown in FIG. 1, system 100 may comprise nodes 110, 120 and 130. In one embodiment, for example, nodes 110, 120 and 130 may comprise wireless nodes arranged to communicate information over a wireless shared media 140. An example of wireless shared media 140 may include RF spectrum. Wireless nodes 110, 120 and 130 may include components and interfaces suitable for communicating information signals over the designated RF spectrum for wireless shared media 140. Examples of a wireless node may include a mobile or cellular telephone, a computer equipped with a wireless access card or modem, a handheld client device such as a wireless PDA, a wireless access point, a base station, a mobile subscriber center, a radio network controller, and so forth. In one embodiment, for example, 110, 120 and/or 130 may comprise wireless devices developed in accordance with the Personal Internet Client Architecture (PCA) by Intel® Corporation, Santa Clara, Calif. Although the embodiments may be illustrated in the context of a wireless communications system, it may be appreciated that the principles discussed herein may also be implemented in a wired communications system as well. The embodiments are not limited in this context.

In one embodiment, nodes 110, 120 and/or 130 may each comprise a processing system. The processing system may include, for example, a processor and a memory subsystem. The processing system may assist in communicating media and control information over wireless shared media 140. In addition, the processing system may be used to execute various operating systems and application programs, sometimes concurrently. Consequently, the processing system may need to support multiple execution contexts in which multiple sets of independent services and applications are executed. These execution contexts may be implemented as collections of processes, in which each process is wholly contained within its own virtual and/or physical address space. This isolation may help ensure that processes do not accidentally or maliciously damage each other. Further, this isolation may ensure that secure information is neither leaked nor stolen across virtual address boundaries.

In one embodiment, the processing system of one or more nodes 110, 120 and 130 may be arranged to include multiple physical domains. More particularly, the processing system may create any number of domains in the memory subsystem, with each domain isolated from the other domains. The multiple physical domains may be used to, for example, isolate different processes from each other. The multiple physical domains may be managed so that a process running in one physical domain is unable to access the physical memory for a separate physical domain.

In one embodiment, various processes may be grouped within a given domain. The processes may be grouped using any type of desired criteria. For example, highly-trusted processes may be executed in a first domain, less-trusted processes may be executed in a second domain, applications using shared data in a third domain, user applications in a fourth domain, high priority applications in a fifth domain, and so forth. The number and types of domains, however, are not limited in this context.

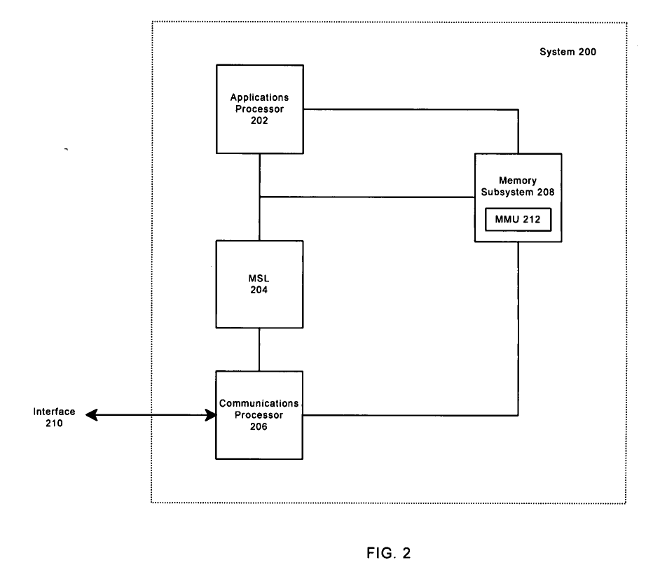

FIG. 2 illustrates a partial block diagram of a processing system 200. Processing system 200 may be representative of a processing system suitable for nodes 110, 120 and/or 130 of system 100 as described with reference to FIG. 1. As shown in FIG. 2, processing system 200 may include multiple elements, such as an applications processor 202, a mobile scalable link (MSL) 204, a communications processor 206, and a memory subsystem 208. Some elements may be implemented using, for example, one or more circuits, components, registers, processors, software subroutines, or any combination thereof. Although FIG. 2 shows a limited number of elements, it can be appreciated that more or less elements may be used in processing system 200 as desired for a given implementation. The embodiments are not limited in this context.

In one embodiment, processing system 200 may include applications processor 202. Applications processor 202 may comprise a general-purpose or special-purpose processor, such as a microprocessor, controller, microcontroller, application specific integrated circuit (ASIC), a programmable gate array (PGA), and so forth. Applications processor 202 may be used to execute various applications, such as data processing operations, modification and manipulation of digital content, and so forth. In one embodiment, for example, a processor may have a reduced instruction set computing (RISC) architecture, such as an architecture based on an Advanced RISC Machines (ARM) architecture. For example, in one embodiment a processor may be a 32-bit version of an XSCALE processor available from Intel Corporation, Santa Clara, Calif. The embodiments are not limited in this context. In various embodiments, a processor may include memory accessing extensions, such as hardware registers, for example.

In one embodiment, processing system 200 may include MSL 204. MSL 204 may be part of an internal bus connecting applications processor 202 and communications processor 206. MSL 204 may comprise a scalable link having a plurality of gating devices to scalably transfer data between applications processor 202 and communications processor 206. The embodiments are not limited in this context.

In one embodiment, processing system 200 may include communications processor 206. Communications processor 206 may be coupled to applications processor 202 via the internal bus, which may include MSL 204. Communications processor 206 may comprise, for example, a digital signal processor (DSP) based on a micro signal architecture. Communications processor 206 may be used to perform various operations, such as manage wireless communications with external sources via wireless interface 210. In certain embodiments, for example, wireless interface 210 may support General Packet Radio Services (GPRS) or another data service. GPRS may be used by wireless devices such as cellular phones of a 2.5 generation (G) or later generation. The embodiments are not limited in this context.

In one embodiment, processing system 200 may include memory subsystem 208. Memory subsystem 208 may be coupled to both applications processor 202 and communications processor 206. Memory subsystem 208 may include any semiconductor device capable of storing data, including both volatile and non-volatile memory. For example, memory subsystem 208 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, a polymer memory such as ferroelectric polymer memory, an ovonic memory, a phase change or ferroelectric memory, a silicon-oxide-nitride-oxide-silicon (SONOS) memory, magnetic or optical cards, floppy disks, optical disks, compact disk read-only memories (CD-ROMs), compact disk rewritables (CD-RWs), digital video disk (DVD), magneto-optical disks, or any other type of media suitable for storing information. The embodiments are not limited in this context.

In one embodiment, memory subsystem 208 may include a memory management unit (MMU) 212. MMU 212 may be arranged to manage memory operations for memory subsystem 208. For example, MMU 212 may manage a physical memory map for the physical memory of memory subsystem 208, perform address translations, implement an access control policy and caching policy, and so forth. The embodiments are not limited in this context.

It is worthy to note that while processing system 200 is shown as having separate components, it may be appreciated that two or more of the components may be integrated into a single device, such as a single semiconductor device. The embodiments are not limited in this context.

In one embodiment, memory subsystem 208 may be separated into different physical domains. A physical domain may comprise, for example, one or more physical partitions of memory. For example, a physical domain may be directly mapped to a set of physical partitions of memory. A physical partition of memory may comprise one or more sections of contiguous or non-contiguous physical memory.

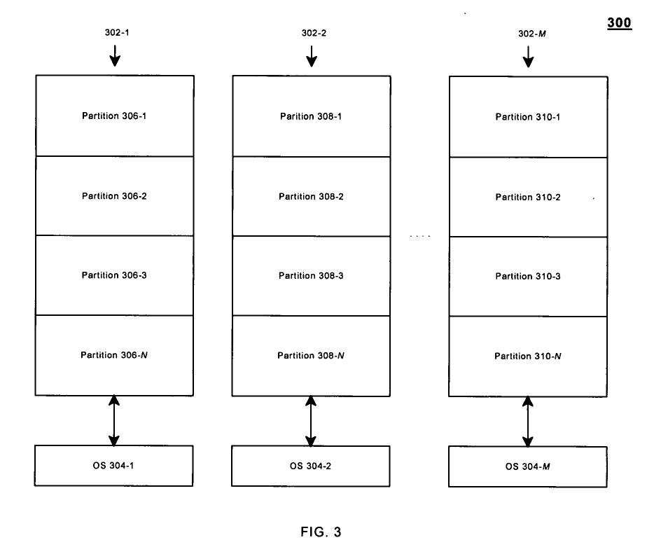

More particularly, applications processor 202 may be used to execute an operating system (OS) for a given node. The OS may comprise, for example, a code base having a reentrant architecture. The OS may separate memory subsystem 208 into multiple physical domains. The multiple physical domains may be used to execute various applications and system services. Multiple physical domains may be created using this architecture which, in certain embodiments, may be based upon functional/logical partitioning. An example of this architecture may be described in more detail with reference to FIG. 3.

FIG. 3 illustrates a memory structure 300. Memory structure 300 may be representative of, for example, a memory structure used by processor 202 for memory subsystem 208. As shown in FIG. 3, memory structure 300 may include multiple physical domains 302-1-M, with M comprising the physical domain count. Each physical domain 302 may be directly mapped to a set of physical partitions of memory. For example, physical domain 302-1 may include partitions 306-1-N, physical domain 302-2 may include partitions 308-1-N, and physical domain 302-M may include partitions 310-1-N, with N comprising the partition count of a physical domain. Each partition may comprise a contiguous or non-contiguous section of physical memory, such as from memory subsystem 208. A partition does not necessarily need to be contiguous with another partition, although that may occur. In addition, each partition may vary in size, and in some cases, the size may be configurable. The embodiments are not limited in this context.

In one embodiment, each physical domain 302 may have a separate OS, such as OS 304-1-M. Each OS 304 may include an OS kernel to perform system management functions, such as memory and file management and allocation of system resources. Alternatively, each OS 304 may be implemented using, for example, a microkernel-based architecture. Although a separate OS 304 is shown for each physical domain 302 in FIG. 3, it may be appreciated that a single OS 304 may be used for all physical domains 302-1-M, or any combination thereof. The embodiments are not limited in this context.

In one embodiment, each physical domain 302 may include one or more processes and/or data. A process may comprise programming code executed by a processor, such as processor 202, for example. Within a given physical domain 302, all physical addressing in the domain may be limited by processor 202 to the physical domain. That is, a given domain is not necessarily allowed to physically address memory spaces outside of the physical partitions that form the physical domain.

In various embodiments, applications and/or services may be segmented in the same physical domain. For example, various applications, interrupt code, processes or threads may be allocated to a given physical domain. The combining of applications and/or services may be accomplished using any desired criteria, such as if the applications are mutually-trusted, if the applications share data, if they are from the same provider, if they are for the same user, if they are for use with different operating systems, and so forth. In such manner, the applications and services in the same physical domain may share memory, thus providing performance gains while maintaining a protection boundary around the set. Examples of mutually-trusted applications may include a word processing application and an email application from the same manufacturer segmented into a single domain, a banking application and an ecommerce application from the same provider, or a Digital Rights Management (DRM) application and content player, and so forth. The embodiments are not limited in this context.

In certain embodiments, for example, physical domains 302 may include a secure physical domain and a non-secure physical domain. For example, physical domain 302-1 may be designated as a secure domain, while physical domain 302-2 may be designated as a non-secure domain. Trusted applications may be executed in secure domain 302-1, and non-trusted applications may be executed in non-secure domain 302-2. An example of non-trusted applications may include certain user applications. If the user applications were to corrupt memory or drivers, the impact would be limited to the user application environment. Examples of secure applications may include downloading of code updates, downloading of secure digital content, authentication code, and so forth. In certain embodiments, for example, a secure domain may include a trusted JAVA™ application, or set of trusted JAVA™ applications and services, that execute in a trusted JAVA™ runtime environment of the secure domain. The embodiments are not limited in this context.

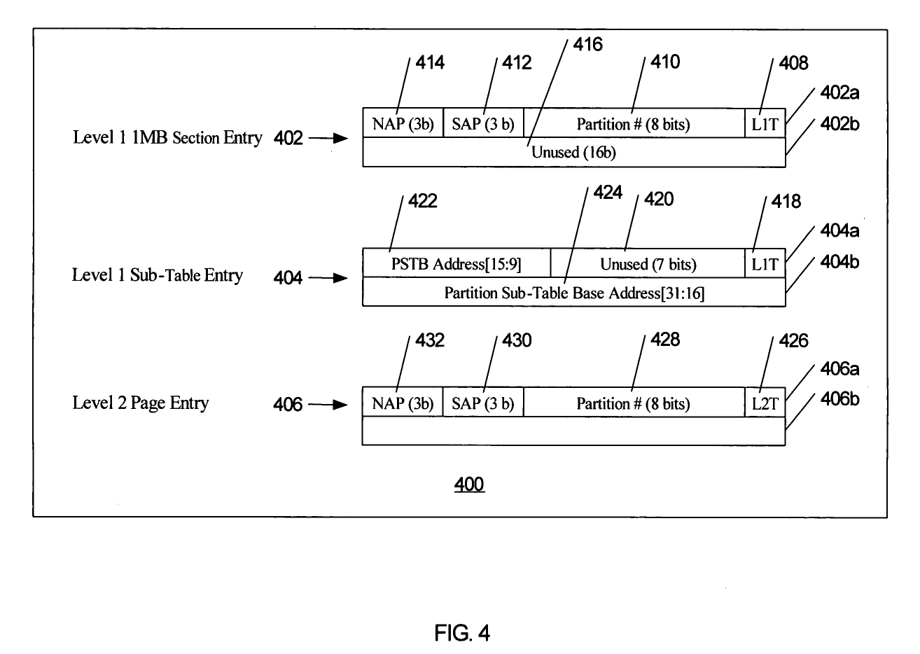

In one embodiment, memory structure 300 may be arranged to operate in accordance with a trusted computing base (TCB) architecture. For example, TCB code may be executed in secure physical domain 302-1. The TCB architecture may isolate processes within a given physical domain, and prevent processes in one domain from accessing the physical memory allocated to another domain. For example, the TCB architecture may cause each OS 304 for each corresponding physical domain 302 to operate as if physical domain 302 begins at a set physical memory location, such as physical memory location zero, for example. This may be accomplished by, for example, creating a set of physical memory addressing tables for each physical domain 302. The physical memory addressing tables receives a physical address generated by a given physical domain 302. The physical address generated by a given physical domain 302 may comprise, for example, a physical address translated from a virtual address using a set of virtual address translation tables. The physical memory addressing tables may map the physical address to a physical page address in physical domain 302. This may be accomplished even though the physical page address may be in a different, and potentially discontiguous, physical domain 302. The TCB architecture may be described in more detail with reference to FIGS. 4, 5, and 6 below.

In one embodiment, processing system 200 may divide a physical address space of a processor into partitions using a partition table, and may restrict processor access to memory and memory-mapped resources using these partitions using, for example, memory accessing extensions, such as hardware registers, for example. Prior to memory accessing extensions, a processor in a non-secure, non-kernel operating mode may be permitted to access resource only in an “active partition” it was operating in, thus making sharing libraries difficult, and making inter-processor communication awkward and inefficient.

Memory accessing extensions permit processing system 200 to access a plurality of partitions, besides the active one, with restrictions on the type of access permitted. Processing system 200 may access such partitions, for example, with no changes to a processor pipeline and no additional bits in the processor's TLBs.

At the system level, applications processor 202 architecture may categorize system resources as secure or non-secure, and may create multiple modes for transaction initiators to operate in. In one embodiment, applications processor 202 may create two modes referred to herein as secure and non-secure modes. A transaction initiator (such as applications processor 202 or a bus-mastering peripheral device) operating in secure mode may access all system resources, however, a transaction initiator operating in non-secure mode may access only resources designated as non-secure. A particular transaction initiator may always operate in secure mode, or may always operate in non-secure mode, or may switch between modes, for example.

In one embodiment, processor 202 architecture may provide a secure hidden partition to enable a trusted execution capability required in highly trusted systems, i.e., the ability to use secrets without revealing them, in a legacy architecture, for example. Secrets, such as cryptographic keys, are the foundation of cryptographic security.

Furthermore, an applications processor 202 incorporating the above architecture may switch between secure and non-secure modes via a small piece of highly-trusted code that operates in a special “monitor” mode, for example.

In one embodiment, applications processor 202 may comprise a plurality of partitions into a physical address space, and enhance the processor so that when in non-secure mode it may access only a subset of the current partitions at any time. In one embodiment partitions may constrain software access, but not hardware access, for example. Partitions operate as an extension of the architecture's secure/non-secure categorization. One embodiment of a partition provides the creation of a new level of access privilege, referred to herein as “kernel” mode, for example. One embodiment provides a manner of entering this mode. Further, partitions may be shared with controlled access privileges, to enhance the efficiency of inter-partition communications and to allow code and data sharing, for example.

As used herein, partitions fulfill the role of what is usually referred to as domains in OS texts. Partitions may be used to control what portion of a physical address space that the CPU may access at any particular time. This is in contrast to MMU 212 operation, which provides that MMU 212 controls what portions of a virtual address space that may be accessed, and the mapping between the virtual and physical address spaces. Partitions may be defined through a hardware interface that may be accessible when applications processor 202 is in a secure mode. In on embodiment, processor 202 may switch only which partitions it may access when in secure privileged mode, or when in a non-secure kernel mode, which is described below. In one embodiment, partition-based access controls may be ignored when processor 202 is operating in “secure” mode. In one embodiment, processing system 200 may support the creation of at least 256 partitions, for example. Memory may be assigned to partitions on a 4 KB granularity, for example, to be compatible with the granularity that operating systems are designed for.

FIG. 4 illustrates the format of entries in a partition table 400 (PTT) structure comprising a two-level look-up table structure, for example. In one embodiment, PTT 400 may reside in secure memory. PTT 400 may be similar to a table that may be used by MMU 212, for example. PTT 400 may be used to provide a mapping from a physical address to a partition number allowing a single entry to identify the partition of either a 1 MB, 64 KB or 4 KB naturally-aligned memory block, for example. PTT 400 also may define the kinds of access allowed to each memory block, both when it is the “native” partition that processor 202 is currently executing in, and when it is a shared partition, for example. PTT 400 entries may be described as follows. The embodiments are not limited in this context.

Accordingly, one embodiment of PTT 400 may provide one or more registers 402, 404, 406, for example. In one embodiment, registers 402, 404, 406 may comprise a 32-bit storage space, for example, to hold one or more entries associated with PTT 400. Registers 402, 404, 406 may comprise a plurality of fields specifying that a particular portion of memory in PTT 400 may be shared and any access rights that may be granted when that portion of memory is shared. Portions of memory in PTT 400 that may be specified for sharing, include but are not necessarily limited to, a particular section (1 MB region) of memory or a page (64 KB or 4 KB region) of memory. In one embodiment, bits or entries in PTT 400 specify that a particular section (1 MB region) or page (64 KB or 4 KB region) of memory may be shared and the access rights that are granted when the block is shared, for example. In one embodiment, separate access rights may be specified when processor's 202 active partition is the same as the partition where the portion of memory is located (e.g., when the task being executed is “native” to the memory block's partition). The embodiments are not limited in this context.

In one embodiment, register 402 may contain a 32-bit Level 1 1 MB section entry. Register 402 may comprise a first 16-bit register 402a and a second 16-bit register 402b in contiguous memory space and may contain a plurality of entries located in a plurality of fields, for example. 16-bit register 402a may comprise fields 408, 410, 412, 414, for example. Field 408 may comprise a two-bit field 408 to hold a partition table entry type. In one embodiment a partition table entry type may be designated as a LT1—Level 1 partition table entry type designated as invalid, 1 MB or Sub-Table entry. A partition table entry type also may be designated as LT2—Level 2 partition table entry type designated as invalid, 64 KB or 4 KB, for example. In one embodiment, field 408 may contain a partition table entry of LT1, for example. Field 410 may comprise an eight-bit entry to indicate the partition number, for example. Field 412 may comprise a three-bit entry to indicate a type of access permission. For example, field 412 may comprise an SAP type of access permission or shared access permission (RWX). Field 414, on the other hand, may comprise a three-bit entry to indicate a NAP type of access permission or native access permission (RWX), for example. 16-bit register 402b may contain similar entries or, as shown in FIG. 4, may contain 16 unused bits or combinations thereof, for example. The embodiments, however, are not limited in this context.

In one embodiment, register 404 may comprise a first 16-bit register 404a and second 16-bit register 404b. Register 404a may comprise fields 418, 420, 422, 424, for example. Field 418 may comprise, for example, a two-bit Level 1 partition table entry type of L1T. As described previously two-bit entry in field 418 may indicate either a Level 1 (e.g., 1 MBit section entry, sub-table entry) partition table entry type (e.g., invalid, section, or sub-table), for example, or a Level 2 partition table entry type (e.g., invalid, 64 KB, or 4 KB). Field 420 may comprise unused bits, for example. Although, field 420 may contain up to seven unused bits, in this example, there may be other entries which may be contained in this PTT 400 space. Field 422, may comprise a seven-bit partition sub table base (PSTB) address, for example, comprising address bits 15:9. Register 404b may comprise field 424 comprising, for example, a 16-bit PSTB address entry (e.g., bits 31:16). The embodiments, however, are not limited in this context.

In one embodiment, register 406 may comprise a first 16-bit register 406a and a second 16-bit register 406b. Register 406a may comprise fields 426, 428, 430, 432. Field 426 may comprise, for example, a two-bit Level 2 partition table entry type of L2T. As described previously the two-bit entry in field 426 may indicate either a Level 1 (e.g., 1 MBit section entry, sub-table entry) partition table entry type (e.g., invalid, section, or sub-table), for example, or a Level 2 partition table entry type (e.g., invalid, 64 KB, or 4 KB). Field 428 may comprise an eight-bit entry to indicate the partition number, for example. Field 430 may comprise may comprise an SAP type of access permission or shared access permission (RWX). Field 432, on the other hand, may comprise a three-bit entry to indicate a NAP type of access permission or native access permission (RWX), for example. Register 406b may contain unused bits, for example. The embodiments, however, are not limited in this context.

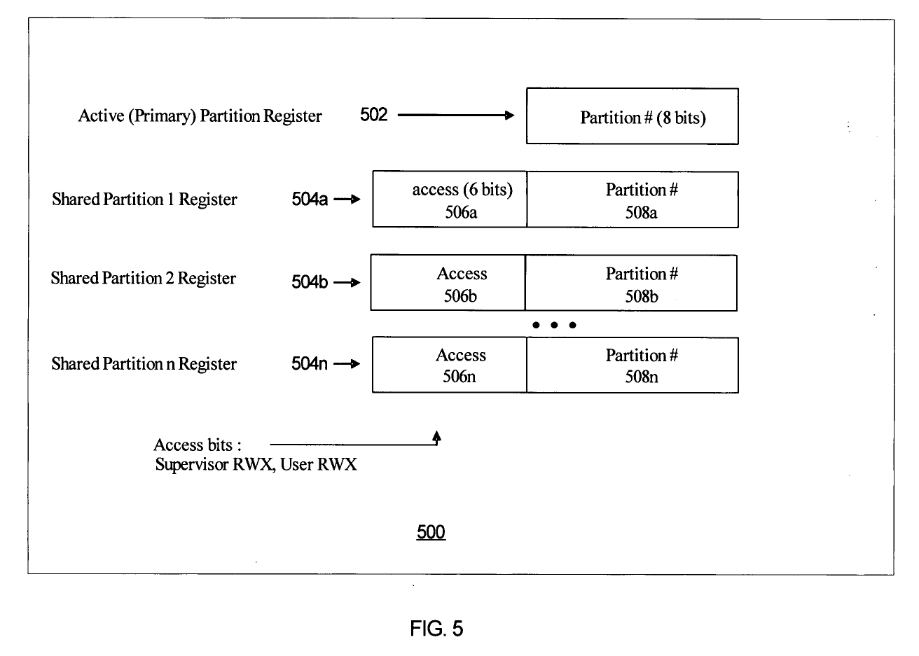

FIG. 5, illustrates a partition access register 500 comprising an active (e.g., primary) partition register 502 and two or more shared partition registers 504a, b, n, for example. In one embodiment, applications processor 202 may comprise partition access register 500, for example. Active partition register 502 and shared partition registers 504a, b, n may be accessed only in secure or kernel mode, unless processor 202 also is in user mode. Primary partition register 502 and shared partition registers 504a, b, n define which partition is the current “native” partition, and which other partitions currently may be accessed by processor 202, for example. These registers 502 and 504a, b, n also may place limitations (read, write, and execute) on access to each shared partition by processor 202. The embodiments are not limited in this context.

As shown in FIG. 5, register 500 allows processor 202 to access a plurality of partitions, in addition to its active partition, with restrictions on the type of access permitted. Shown in FIG. 5 is one embodiment of an instantiation of register 500 showing active partition access register 502 and shared partition access registers 504a, b, n in table walk logic, for example. Although register 500 illustrates one active partition register 502 and two or more shared partition registers 504a, b, n, any number of registers may be implemented without departing from the scope of the embodiments. Each shared partition register 504a, b, n may comprise one or more fields. For example, in one embodiment, each shared partition register 504a, b, n may comprise access field 506a, b, n, respectively, and partition number field 508a, b, n, respectively, for example. Each shared partition register 504a, b, n may contain access rights of processor 202, for example. In one embodiment access rights may be defined by entries (e.g., in the form of one or more bits) stored in access fields 506a, b, n and may include separate user and privileged (or supervisor) modes “RWX” access rights, for example. In one embodiment, indicated access rights may further restrict the rights given by virtual memory manager (VMM) page tables, for example. Shared partition registers 504a, b, n also may comprise partition number fields 508a, b, n, respectively, each of which may contain a number of shared partitions that may be accessed by processor 202, and its access rights as determined by access fields 508a, b, n, respectively, for example. The embodiments are not limited in this context.

PTT 400 may be accessed by the same functional unit that performs table walks used by MMU 212, for example. A PTT 400 table walker may read secure memory even when processor 202 is in a non-secure mode. Unless processor 202 is in secure mode, the partition number in the relevant entry of PTT 400 must match either the active (e.g., primary) partition register 502, or one of the shared partition registers 504a, b, n, for example. The embodiments are not limited in this context.

Access privileges read from PTT 400 may be combined with those read from the page tables and, if appropriate, those read from the matching shared partition register 504a, b, n, for example. An access may be allowed only if both tables permit it, and, in the case of shared partitions, if partition register 500 (e.g., registers 502 and 504a, b, n) settings permit it. If processor 202 is in kernel mode, the native permissions from PTT 400 are always used. Otherwise, if the entry's partition number matches the active partition register 502, the NAP from PTT 400 may be used. If the entry's partition number matched a shared partition register 504a, b, n, the SAP from PTT 400 may be used. The active partition 502 number (or “zero” if processor 202 is in kernel mode) and the combined access privileges may be stored in a TLBs of processor 202, for example, as part of a usual virtual-to-physical mapping result, with the partition number acting like additional tag bits that, on a TLB access, must match active partition register 502 (which acts as if it is “zero” when in kernel mode). The embodiments are not limited in this context.

Operations for the above system and subsystem may be further described with reference to the following figures and accompanying examples. Some of the figures may include programming logic. Although such figures presented herein may include a particular programming logic, it can be appreciated that the programming logic merely provides an example of how the general functionality described herein can be implemented. Further, the given programming logic does not necessarily have to be executed in the order presented unless otherwise indicated. In addition, the given programming logic may be implemented by a hardware element, a software element executed by a processor, or any combination thereof. The embodiments are not limited in this context.

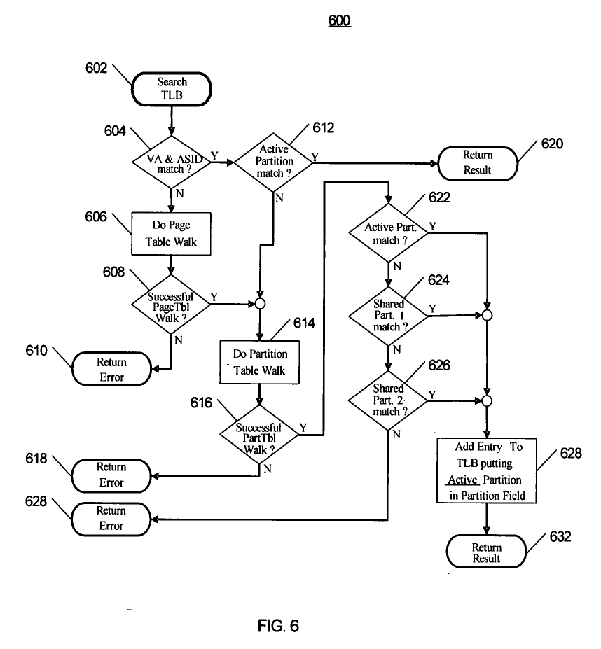

FIG. 6 illustrates one embodiment of a programming logic 600 for performing a memory translation and partition check. In one embodiment, programming logic 600 may be considered a page table walk and partition table logic for non-secure, non-kernel processor modes, for example. In one embodiment, programming logic 600 may include a plurality of elements, although embodiments are not limited in this context. Accordingly, in one embodiment, programming logic 600 may comprise a first portion to force a table walk whenever a partition field in a TLB entry does not match an active partition without signaling that an error occurred. In one embodiment, programming logic 600 also may comprise a second portion to check a shared partition register against a partition of a memory block, as well as checking the active partition register, when determining if a result of a partition table walk is a match. In one embodiment, programming logic 600 also may comprise a third portion, to write an active partition register value into a partition field of TLB entry if a partition table walk matches either an active partition register or a shared partition register. This portion allows TLB comparisons to be made without using contents of shared partition registers, for example. It also allows different active partitions to have access to the same shared partition but with different access rights. In one embodiment, a TLB does not have to be flushed when the active partition is changed. The embodiments are not limited in this context.

Using various mechanisms, the partition management software may first designate certain blocks of memory within partitions as shareable outside that partition, and may define what kind of sharing is allowed (execute, read-only, read-write, write-only, etcetera). These sharing and access permissions are expressed in partition register 500 and in entries in PTT 400 for a designated region of memory. Partition management in processing system 200 and/or processor 202 may be performed by secure privileged code, and the partition tables may reside in secure memory, for example. The partition table hardware may perform read-only accesses of the partition tables even when operating in non-secure modes. In contrast, software running on processor 202 generally may not do so. The embodiments are not limited in this context.

Task and memory management software, which may operate in non-secure privileged kernel mode or secure privileged mode may be used to manage the active and shared partition registers 502 and 504a, b, n in the table walk unit of MMU 212, for example. Using information provided to it by the partition manager on the location of shared and non-shared memory for each partition, and information in the executing tasks about what needs to be accessed, the task and memory management software configures the partition registers and the page tables appropriately. The embodiments are not limited in this context.

TLBs may include an eight-bit partition number field in a result portion of each entry. TLB miss handling logic may incorporate logic to walk the partition tables, using the partition table base register. This logic may read from secure areas of memory (where the partition table would reside) even when processor 202 is in non-secure mode.

Partition management code may be added to the OS operating system of processor 202, for example. This code may be executed partly in kernel mode (for partition switching) and partly in secure-privileged mode, for example. Further, in one embodiment, memory management software (such as the software that manages the page tables) may be adaptable to the non-contiguous nature of the physical memory available to any particular partition, for example.

A top level flow diagram of programming logic 600 of a page table and partition table walk mechanism is now described with reference to FIG. 6. As shown in FIG. 6, programming logic 600 may be representative of the operations executed by one or more systems described herein, such as system 100 and/or system 200. The programming logic is used to process a memory operation request (MOR), which comprises a virtual address (VA), address-space identifier (ASID), and the operation type. As shown in programming logic 600, at block 602 the process begins by searching the TLB. At decision block 604, if the VA and the ASID provided in the MOR do not both match the VA and ASID stored in some entry in the TLB, the process proceeds to block 606 and performs a page table walk. At decision block 608, if the page table walk is not successful, the process proceeds to block 610 and returns an error. The embodiments are not limited in this context.

At decision block 608, if the page table walk is successful, the process proceeds to block 614 and performs a partition table walk. Also, at decision block 604, if a TLB entry was found that matches the VA and the ASID provided in the MOR the process proceeds to decision block 612. At decision block 612, if the active partition in register 502 matches the partition field stored in the entry found in the TLB that matches the VA and ASID in the MOR, the process continues to block 620 and returns a result. The embodiments are not limited in this context.

At decision block 612, if the active partition in register 502 does not match the partition field in the entry found in the TLB that matches the VA and ASID in the MOR, the process continues to block 614 and performs a partition table walk. At decision block 616, if the partition table walk is not successful, the process continues to block 618 and returns an error. The embodiments are not limited in this context.

At decision block 616, if the partition table walk is successful, the process continues to block decision block 622 and if the active partition in register 502 does not match the results of the partition table walk, the process proceeds to decision block 624. At decision block 624, if shared partition 1 in register 504a does not match the results of the partition table walk, the process proceeds to decision block 626. At decision block 626, if shared partition 2 in register 504b does not match the results of the partition table walk, the process proceeds to block 628 and returns an error. The embodiments are not limited in this context.

If at decision block 622 or decision block 624 or decision block 626 there is a match between the results of the partition table walk and either the active partition, shared partition 1 or shared partition 2, the process proceeds to block 630 and adds an entry to the TLB putting the active partition in register 502 in partition field of the new TLB entry. The process continues to block 632 and returns a result. The embodiments are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor. In another example, an embodiment may be implemented as dedicated hardware, such as a circuit, an application specific integrated circuit (ASIC), Programmable Logic Device (PLD) or digital signal processor (DSP), and so forth. In yet another example, an embodiment may be implemented by any combination of programmed general-purpose computer components and custom hardware components. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, various types of Digital Versatile Disk (DVD), a tape, a cassette, or the like. The instructions may include any suitable type of code, such as source code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth. The embodiments are not limited in this context.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. An apparatus, comprising:
a memory subsystem having physical memory divided into a plurality of partitions, said memory subsystem comprising a partition table, wherein said partition table comprises entries to specify a section of said memory subsystem that can be shared by said processor; and
a processor to connect to said memory subsystem, said processor comprising a partition access register, said processor to access said plurality of said partitions in accordance with said partition table and said partition access register.

2. The apparatus of claim 1, wherein said partition table comprises entries to specify access rights of said processor when said section of said memory is shared by said processor.

3. The apparatus of claim 2, wherein said partition table comprises entries to specify separate access rights of said processor when said processor's active partition is the same as the section of said memory shared by said processor.

4. An apparatus, comprising:
a memory subsystem having physical memory divided into a plurality of partitions, said memory subsystem comprising a partition table; and
a processor to connect to said memory subsystem, said processor comprising a partition access register, said processor to access said plurality of said partitions in accordance with said partition table and said partition access register, wherein said partition access register comprises an active partition register and at least one shared partition register to define a number of partitions said processor can access.

5. The apparatus of claim 4, wherein said shared partition registers define limitations on access to said shared number of shared partitions.

6. A system, comprising:
an antenna;
a transceiver to connect to said antenna; and
a processing system to connect to said transceiver, said processing system including a processor and a memory subsystem, said memory subsystem to include physical memory divided into a plurality of partitions, said memory subsystem to include a partition table, wherein said partition table comprises entries to specify a section of said memory subsystem that can be shared by said processor; and said processor to connect to said memory subsystem, said processor to include a partition access register, said processor to access said plurality of said partitions in accordance with said partition table and said partition access register.

7. The system of claim 6, wherein said partition table comprises entries to specify access rights of said processor when said section of said memory is shared by said processor.

8. The system of claim 7, wherein said partition table comprises entries to specify separate access rights of said processor when said processor's active partition is the same as the section of said memory shared by said processor.

9. A system, comprising:
an antenna;
a transceiver to connect to said antenna; and
a processing system to connect to said transceiver, said processing system including a processor and a memory subsystem, said memory subsystem to include physical memory divided into a plurality of partitions, said memory subsystem to include a partition table; and said processor to connect to said memory subsystem, said processor to include a partition access register, said processor to access said plurality of said partitions in accordance with said partition table and said partition access register, wherein said partition access register comprises an active partition register and at least one shared partition register to define a number of partitions said processor can access.

10. The system of claim 9, wherein said shared partition register defines limitations on access to said shared number of shared partitions.

11. A method comprising:
designating a section of memory within a plurality of partitions as shareable outside an active partition; and
defining a type of sharing permitted for said active partition in a partition table register.

12. The method of claim 11, further comprising forcing a table walk when a partition field in a translation lookaside buffer does not match said active partition.

13. The method of claim 11, further comprising checking a shared partition register against a partition of said section of memory.

14. The method of claim 13, further comprising checking an active partition register in said partition table register.

15. The method of claim 12, further comprising writing said active partition register value into a partition field of a translation lookaside buffer entry if said partition table walk matches either said active partition register or one of said shared partition registers.

16. An article, comprising:
a storage medium;
said storage medium including stored instructions that, when executed by a processor, are operable to designate a section of memory within a plurality of partitions as shareable outside an active partition, and to define a type of sharing permitted for said active partition in a partition table register.

17. The article of claim 16, wherein the stored instructions, when executed by a processor, are further operable to force a table walk when a partition field in a translation lookaside buffer does not match said active partition.

18. The article of claim 16, wherein the stored instructions, when executed by a processor, are further operable to check a shared partition register against a partition of said section of memory.

19. The article of claim 18, wherein the stored instructions, when executed by a processor, are further operable to checking an active partition register in said partition table register.

20. The article of claim 17, wherein the stored instructions, when executed by a processor, are further operable to write said active partition register value into a partition field of a translation lookaside buffer entry if said partition table walk matches either said active partition register or one of said shared partition registers.
